(19) United States
(12) Patent Application Publication
(10) Pub. No.: US 2003/0045347 A1
(43) Pub. Date: Mar. 6, 2003

(54) Game machine, and method for controlling the game machine

(75) Inventor: Katsuhiko Watanabe, Tokyo (JP)

Correspondence Address: SUGHRUE MION, PLLC, 2100 PENNSYLVANIA AVENUE, N.W., WASHINGTON, DC, 20037, US

(73) Assignee: KONAMI CORPORATION

(21) Appl. No.: 10/230,319

(22) Filed: Aug. 29, 2002

(30) Foreign Application Priority Data
Aug. 30, 2001 (JP) P2001-261700

(51) Int. Cl. A63F 13/00; A63F 9/24

(52) U.S. Cl. 463/20

(57) ABSTRACT

A first current displayed symbol determination section (321) determines that symbol “RED7” is currently displayed at an arbitrary symbol display position on a main display section (310). On the basis of the result of determination made by the first current displayed symbol determination section (321), a state change section (322) changes, from an initial state to a valid state, the state of a display area corresponding to a symbol display position at which the symbol “RED7” is currently displayed. A valid combination determination section (324) determines whether or not a valid display area on the display section (330) forms a predetermined valid combination. A point bringing section (325) gets points in accordance with a result of determination made by the valid combination determination section (324).

### BACKGROUND OF THE INVENTION

The invention relates to a game machine, a method for controlling the game machine, and a control program for implementing the method. Particularly, the invention relates to a game machine and to a method and program for controlling the game machine, which give a player a feeling of expectation toward a game played in a basic gaming status and enable enhancement of a gaming characteristic in the basic gaming status.

The following description is provided, by means of taking a slot machine installed in an amusement arcade or a Pachinko Parlor as an example of a related-art game machine. A related-art slot machine has a predetermined number of spinning reels (e.g., three spinning reels) having various types of symbols printed thereon. Respective reels which are spun by corresponding reel drive motors (e.g., stepping motors) are stopped at timings corresponding to those at which stop buttons assigned to the respective reels are pressed. When symbols that would form a predetermined winning combination are aligned with a valid line (i.e., a winning line) when the three reels have come to a standstill, the game machine pays game medals in a number corresponding to the winning combination or gives the player the right to play a bonus game.

Next, a game which is available on the related-art slot machine in a basic gaming status will now be described. When a start lever is actuated after a game medal has been inserted or bet, a failure or a winning combination is determined through internal random selection. Here, the internal random selection will now be described. In random selection the slot machine determines in advance, on a random basis, occurrence of a failure or a hit (i.e., a winning combination) and further the hit is classified to a big hit (hereinafter referred to as a big bonus or “BB”); a medium hit (hereinafter referred to as a regular bonus “RB”); a small hit, such as a small winning combination or a small winning combination that would result in a single win; or a replay game (hereinafter, a determination made through internal random selection will be called a “preliminary determination”).

For example, if a small winning combination has been determined in advance through internal random selection and if symbols that would form the small winning combination (e.g., WATERMELON-WATERMELON-WATERMELON) are aligned with a valid line when the player has stopped the reels by means of pressing stop buttons, a win is achieved through the small winning combination. Game medals are paid out in a number corresponding to the small winning combination, and the next game is played.

For example, if a big-bonus winning combination (hereinafter simply called a “BB winning combination”) has been determined in advance through internal random selection and if symbols that would form the BB winning combination (e.g., 7-7-7) are aligned with a valid line when the player has stopped the reels by means of pressing the stop buttons, a win is achieved through the BB winning combination, and the game proceeds to a big bonus game (hereinafter simply called a “BB game”).

Next, a game played in a special gaming status will be described. A special game designates a regular-bonus game (hereinafter simply called an “RB game”) which starts as a result of a win having been achieved through an RB winning combination during the course of a basic game or a basic game played during the course of a BB game. Only one game medal can be bet during the special game, and a game is played while only the center line is set as a winning line. In contrast with a basic game, the special game does not include a plurality of winning combinations and results in only a single win or a failure. Thus, the special game is set such that a win is achieved with considerably high probability. In this case, symbols for a replay game are used in place of symbols that would form a win in an RB game. The RB game can be played up to a maximum of two times. If a win has been achieved eight times, the RB game is terminated even before the win is achieved twelve times.

An example BB game will now be described. The BB game consists of a maximum of thirty “small-winning-combination games” (each game correspond to a basic game in effect during the course of a high-probability game) and a maximum of three RB games. During the course of a “small-winning-combination game,” a win is achieved with very high probability through a small winning combination. Recently, there has been introduced a game machine which during the course of a “small-winning-combination game” informs the player of symbols that would form a small winning combination and have been determined in advance, by means of a liquid-crystal display device, a dot-matrix display device, or a like device. When predetermined symbols (e.g., symbols that would form a replay game) are displayed as a result of stoppage of the reels during the course of the “small-winning-combination game,” an RB game is started. The BB game is to be terminated when a “small-winning-combination game” has been performed a given number of times (e.g., 30 times) or when a win has been achieved a predetermined number of times (e.g., three times) through an RB game. After the BB game has finished, the game returns to a basic game.

As mentioned above, the related-art game machine pays out game medals when a win has been achieved through a small winning combination during the course of games provided in a basic game. However, the player plays those games merely for the purpose of achieving a win through a BB winning combination, which would cause the game to proceed to a BB game where the player can acquire a large amount of game medals. Thus, the games provided in a basic game are considered to be consumable games which are to be merely repeated until symbols that would form a BB winning combination are aligned with a valid line as a result of stoppage of the reels. Thus, the games become boring to the player.

### SUMMARY OF THE INVENTION

The invention has been conceived under the above-described circumstances and aims at providing a game machine which gives a player a feeling of expectation in a game played in a basic game and enables further enhancement of a gaming characteristic of a game in a basic game.

In order to solve the aforesaid object, the invention is characterized by having the following arrangement.

(1) A game machine comprising:

a main display unit for variably displaying symbols of a plurality of kinds;

a sub display unit including display areas corresponding to respective symbol display positions of the main display unit;

a first current displayed symbol determination section for determining whether or not a first predetermined symbol is currently displayed at an arbitrary display position on the main display unit;

a state change unit which changes, from an invalid state to a valid state, the state of the display area corresponding to the symbol display position at which the first predetermined symbol is currently displayed, on the basis of a result of determination made by the first current displayed symbol determination section;

a valid combination determination unit for determining whether or not the valid display area on the sub display unit forms a predetermined combination; and

a point bringing unit for giving points in accordance with a result of determination made by the valid combination determination unit.

(2) The game machine according to (1), wherein the point bringing unit gives points in accordance with the type of the predetermined valid combination.

(3) The game machine according to (1), further comprising a point storing unit for holding points in accordance with a determination result made by the valid combination determination unit, wherein the point bringing unit gets points stored in the point storing unit at a timing instructed by a player.

(4) The game machine according to (1), further comprising a second current displayed symbol determination unit for determining whether or not a second predetermined symbol is currently displayed at an arbitrary symbol display position on the main display unit,

wherein the state change unit changes, to the invalid state, the state of the display area corresponding to the symbol display position at which the second predetermined symbol is currently displayed, in accordance with a result of determination made by the second current displayed symbol determination unit.

(5) The game machine according to (1), further comprising a invalid state change unit for changing the states of all display areas on the sub display unit to the invalid state when the number of times the main display unit displays currently display symbols has reached a predetermined level.

(6) The game machine according to (1), further comprising a game shift unit for shifting a game to a promotional game given by the point bringing section when a value of points reaches to a predetermined value.

(7) The game machine according to (1), wherein the game advantageous to the player is a game of high probability of prize.

(8) The game machine according to (1), further comprising a game medal payout controller for paying game medals in accordance with points gotten by the point bringing unit.

(9) A method of controlling a game machine including a main display unit for displaying a plurality of spinning reels having a plurality of symbols, a sub display unit including display areas corresponding to respective symbol display positions of the main display unit, and a controller for spinning and stopping the reels such that at least one symbol on each reel is displayed to a player of the game machine, the method comprising the steps of:

first determining whether or not a first predetermined symbol is currently displayed at an arbitrary display position on the main display unit;

changing, from an invalid state to a valid state, the state of the display area corresponding symbol is currently displayed, on the bases of a result of the first determining step;

second determining whether or not the valid display area on the sub display unit forms a predetermined combination; and

giving points in accordance with a result of the second determining step.

By means of the game machine and the control program according to the invention, the first current displayed symbol determination section determines whether or not a first predetermined symbol is currently displayed at an arbitrary display position on the main display unit. On the basis of a result of determination made by the first current displayed symbol determination section, the state change unit changes, from an invalid state to a valid state, the state of a display area corresponding to a symbol display position at which the first predetermined symbol is currently displayed. The valid combination determination unit determines whether or not the valid display area on the sub display unit forms a predetermined combination. The point bringing unit gets points in accordance with a result of determination made by the valid combination determination unit.

By means of the method of controlling a game machine according to the invention, when in the first current displayed symbol determination step a determination is made that a first predetermined symbol is currently displayed at an arbitrary display position on the main display unit, the state of a display area corresponding to a symbol display position at which the first predetermined symbol is currently displayed is changed from an initial state to a first state in the first state change step. When, in the combination determination step, a determination is made that the display area of first state on the sub display unit forms a predetermined combination, points are given in a point bringing step.

A game which has an element of giving points and is to be played on the display section is added to the game to be played on the main display section in a basic game. As a result, a feeling of expectation to acquire points can be given during a game to be played in a basic game. Hence, the gaming characteristic of a game to be played in a basic game can be greatly enhanced. Consequently, an arcade or parlor where such a game machine having a higher gaming characteristic is to be installed can expect an increase in profits.

In the game machine according to the invention, the point bringing unit gives points in accordance with the type of the predetermined valid combination. Thus, predetermined valid combinations of a plurality of types are available, and the point bringing unit gives points in accordance with the type of predetermined valid combination. Hence, a game to be played in a basic gaming status is broadened, and the gaming characteristic can be greatly enhanced.

In the game machine of the invention, the point storing unit holds points in accordance with the result of the determination made by the valid combination determination unit.

The point bringing unit gives points stored in the point storing unit when a player instructs. Accordingly, the player can determine, according to his/her judgment, whether the points stored in the point storing section are given immediately or the points are given only after a valid combination which enables acquisition of a greater number of points is formed. Hence, a game to be played in a basic gaming status is broadened, and the gaming characteristic can be greatly enhanced.

In the game machine of the invention, the second current displayed symbol determination unit makes a determination as to whether or not a second predetermined symbol is currently displayed at an arbitrary symbol display position on the main display unit. In accordance with a result of determination made by the second current displayed symbol determination unit, the state change unit changes, to the invalid state, the state of a display area corresponding to a symbol display position at which the second predetermined symbol is currently displayed.

As mentioned above, when the second current displayed symbol determination unit has determined that a second predetermined symbol is currently displayed at an arbitrary symbol display position on the main display unit, the state change unit changes, to the invalid state, the state of a display area corresponding to a symbol display position at which the second predetermined symbol is currently displayed. Even when the display area on the sub display unit has become valid, the valid display area may become invalid if a second predetermined symbol is currently displayed on the main display unit. Hence, a game to be played in a basic gaming status is broadened, and the gaming characteristic can be greatly enhanced.

In the game machine of the invention, when the number of times the main display unit displays currently display symbols has reached a predetermined level, the invalid state change unit changes the states of all display areas on the sub display unit to the invalid state. In this way, when the number of times the main display unit displays currently display symbols has reached a predetermined level; that is, when the number of games to be played in a basic game has reached a predetermined level, the invalid state change unit changes the states of all display areas on the sub display unit to the invalid state. The player must form a predetermined valid combination on the display means in a basic game within a predetermined number of games. Further, when a certain valid combination is formed, the player determines whether points to be given for the valid combination are given immediately or held in the point storing unit. Thus, games are given a level of diversity, thereby broadening games to be played in a general playing state and greatly enhancing a gaming characteristic.

In the game machine of the invention, when points are given by the point bringing unit, the game shift unit shifts a game to another state advantageous to the player. Hence, the game to be held in a basic game can be changed to a game which can be shifted to a game advantageous to the player. Hence, the player is given a feeling of expectation toward a game played in a basic gaming status. Consequently, the gaming characteristic in the basic gaming status can be greatly enhanced.

Particularly, in the game machine of the invention, the game advantageous to the player is preferably a game of high probability of prize. Consequently, a game to be played in a basic game can be taken as a game which can be shifted to a game of high probability in which an increase in the number of acquirable game medals can be expected. Hence, the player is given a feeling of expectation toward a game played in a basic gaming status. Consequently, the gaming characteristic in the basic gaming status can be greatly enhanced.

In the game machine of the invention, when points are given by the point bringing unit, the setting change unit changes settings pertaining to the game advantageous to the player in accordance with the points given by the point bringing unit. As a result, a game to be played in an ordinary game can be changed such that the number of game medals given to the player during the course of a game advantageous to the player is increased from that determined by ordinary settings. Hence, the player is given a feeling of expectation toward a game played in a basic gaming status. Consequently, the gaming characteristic in the basic gaming status can be greatly enhanced.

Particularly, in the game machine of the invention, the settings pertaining to the game advantageous to the player are preferably settings pertaining to the number of game medals which can be acquired in a game of high probability. As a result, a game to be played in an ordinary game can be changed such that the number of game medals given during the course of a game of high probability is increased from that determined by ordinary settings. Hence, the player is given a feeling of expectation toward a game played in a basic gaming status. Consequently, the gaming characteristic in the basic gaming status can be greatly enhanced.

Particularly, in the game machine of the invention, the settings pertaining to the game advantageous to the player are preferably settings pertaining to the number of game medals which can be acquired during a special game in a game of high probability of prize. As a result, a game to be played in an ordinary game can be taken as a game which can be changed such that the number of wins attainable through special games during the course of a game of high probability in a basic game is increased from that determined by ordinary settings. Hence, the player is given a feeling of expectation toward a game played in a basic gaming status. Consequently, the gaming characteristic in the basic gaming status can be greatly enhanced.

Particularly, in the game machine of the invention, the settings pertaining to the game advantageous to the player are preferably settings pertaining to the number of times occurrence of a small winning combination is indicated in a basic game. As a result, a game to be played in an ordinary game can be taken as a game which can be changed such that the number of times occurrence of a small winning combination is indicated in a basic game is increased from that determined by ordinary settings. Hence, the player is given a feeling of expectation toward a game played in a basic gaming status. Consequently, the gaming characteristic in the basic gaming status can be greatly enhanced.

Particularly, in the game machine of the invention, the settings pertaining to the game advantageous to the player are preferably settings pertaining to the number of times occurrence of a small winning combination is indicated in a special game. As a result, a game to be played in an ordinary game can be taken as a game which can be changed such that the number of times occurrence of a small winning combination is indicated in a special game is increased from that determined by ordinary settings. Hence, the player is given a feeling of expectation toward a game played in a basic gaming status. Consequently, the gaming characteristic in the basic gaming status can be greatly enhanced.

Particularly, in the game machine of the invention, the settings pertaining to the game advantageous to the player are preferably settings pertaining to the probability of occurrence of a replay game in a special game. As a result, there can be made settings such that the probability of occurrence of a replay game in a special game is increased on the basis of the points acquired through a game in a basic game. Hence, the probability of attainment of wins during a basic game is increased without involvement of a decrease in the number of game medals. Therefore, a game to be played in an ordinary game can be taken as a game which can be changed such that the number of game medals to be acquired in a promotional game is increased from that determined by ordinary settings. Hence, the player is given a feeling of expectation toward a game played in a basic gaming status. Consequently, the gaming characteristic in the basic gaming status can be greatly enhanced.

In the game machine of the invention, the game medal payout controller pays game medals in accordance with points given by the point bringing unit. As a result, a game to be played in an ordinary game can be taken as a game for which a further increase in the number of acquirable game medals can be expected. Hence, the player is given a feeling of expectation toward a game played in a basic gaming status. Consequently, the gaming characteristic in the basic gaming status can be greatly enhanced.

### BRIEF DESCRIPTION OF DRAWINGS

FIG. 1 is a perspective view showing an external view of a slot machine to which the invention is applied;

FIG. 2 is a descriptive view showing general winning combinations of the slot machine;

FIG. 3 is a block diagram showing a slot machine according to a first embodiment;

FIG. 4 is a flowchart for describing processing to be performed by the slot machine of the first embodiment;

FIG. 5 is a descriptive view showing a main display section 310 and a sub display section 330 during the course of the processing performed by the slot machine of the first embodiment;

FIG. 6 is a block diagram showing a slot machine according to a second embodiment of the invention;

FIG. 7 is a flowchart for describing processing to be performed by the slot machine of the second embodiment; and

FIG. 8 is a flowchart for describing the processing to be performed by the slot machine of the second embodiment.

### DETAILED DESCRIPTION OF PREFERRED EMBODIMENTS

With reference to the accompanying drawings, embodiments of a slot machine will be described in detail in descending sequence of first and second embodiments serving as examples of a game machine of the invention. In the descriptions of the embodiments, a game machine according to the invention and a method of controlling the game machine will be described in detail. A control program of the invention is a program which causes a computer to implement functions serving as means of the game machine. Hence, the following descriptions of the game machine include explanations of the program.

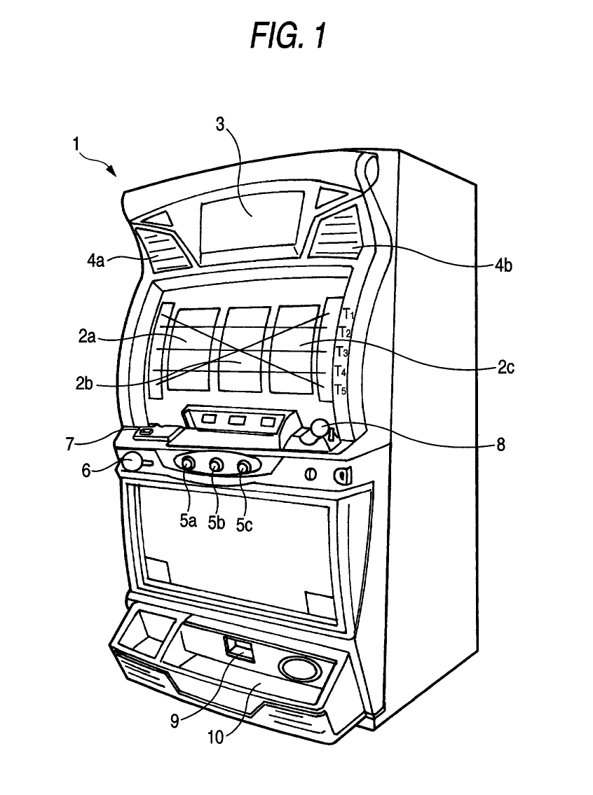

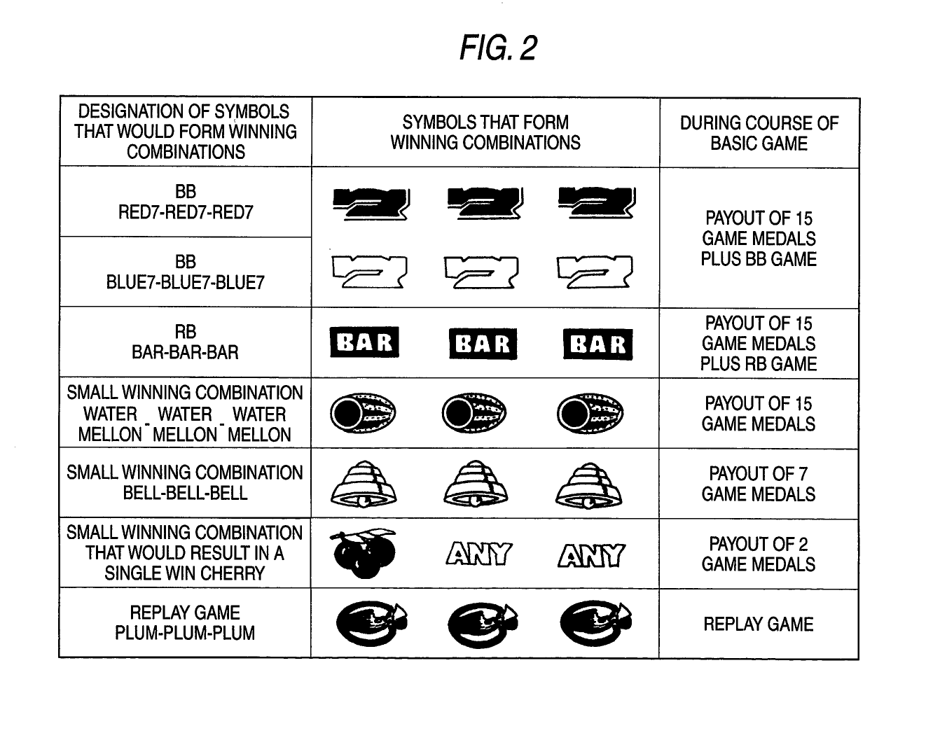

Before respective embodiments are described, the schematic configuration of a slot machine to which the embodiments are applied will be described by reference to FIGS. 1 and 2. FIG. 1 is a perspective view showing an external view of a slot machine to which the invention is applied. FIG. 2 is a descriptive view showing general winning combinations. As shown in FIG. 1, provided on the front of the slot machine are display windows 2a, 2b, and 2c for displaying a predetermined number of symbols printed on a plurality of spinning reels. A liquid-crystal display device 3 and speakers 4a, 4b are provided above the display windows 2a, 2b, and 2c. Provided below the display windows 2a through 2c of the slot machine are stop buttons 5a, 5b, and 5c allocated to the respective spinning reels; a start lever 6; a bet button 7; and a game medal insertion slot 8. Provided in a lower portion of the slot machine is a game medal receiver 10 for storing payout game medals output by way of a game medal output port 9.

In back of the respective display windows 2a through 2c, first through third spinning reels are rotatably supported while being disposed side by side horizontally and concentrically with each other. Symbols, such as “CHERRY,” “WATERMELON,” “BELL,” “7,” “BAR,” are provided on respective outer peripheral surfaces of first through third spinning reels. The slot machine is set such that a win is achieved by means of any one of the winning combinations shown in FIG. 2 being aligned with a valid winning line. Provided across the surfaces of the display windows 2a through 2c of the three spinning reels are a total of five stop lines (i.e., winning lines) T1 through T5; namely, three horizontal stop lines, a downward diagonal line, and an upward diagonal line. In accordance with the number of inserted game medals (i.e., the number of medals bet), the number of valid stop lines can be increased. The slot machine shown in FIG. 1 is a rotary slot machine which drives spinning reels by means of motors. However, the invention can also be applied to a video slot game, by mean of which a player plays a game while viewing spinning reels appearing on a liquid-crystal screen.

First Embodiment

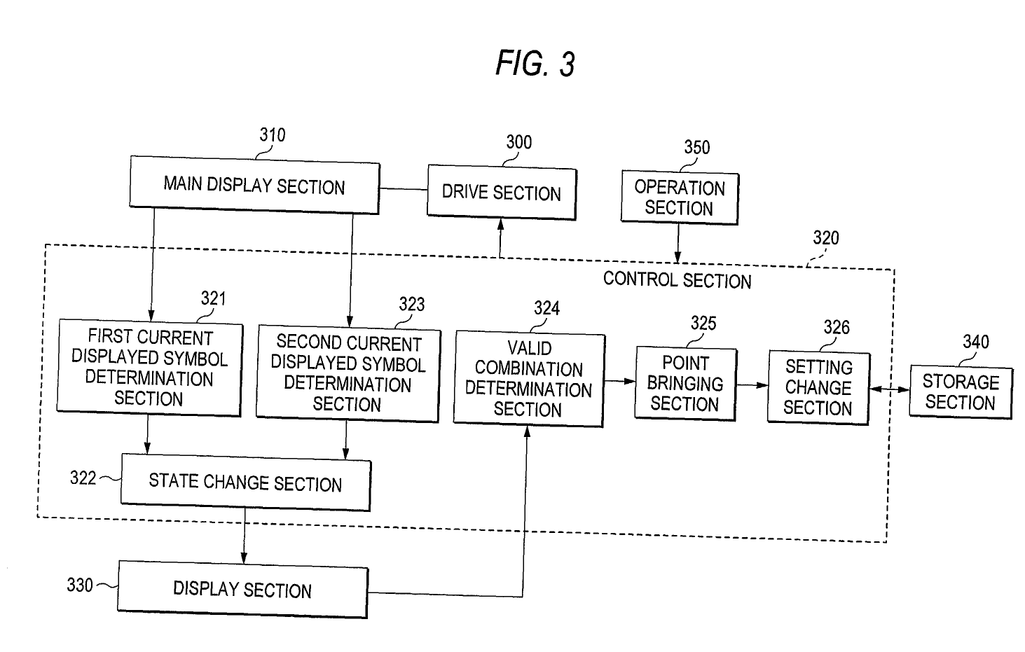

FIG. 3 is a schematic view showing a slot machine according to a first embodiment of the invention. As shown in FIG. 3, the slot machine according to the first embodiment is constituted of: a drive section 300; a main display section 310; a first section 321 for determining a symbol to be currently displayed (hereinafter called a “first current displayed symbol determination section”); a second section 323 for determining a symbol to be currently displayed (hereinafter called a “second current displayed symbol determination section”); a status change section 322; a valid combination determination section 324; a control section 320 having a point bringing section 325 and a setting change section 326; a sub display section 330; a storage section 340; and an operation section 350.

The drive section 300 is embodied by a stepping motor or the like and drives spinning reels on whose peripheral surfaces a plurality of types of symbols are printed, in accordance with a drive pulse signal supplied from the control section 320. The main display section 310 is embodied by means of the display window 2 and a predetermined number of symbols which are printed on the respective spinning reels and are to be displayed on the display window 2. When the spinning reels have come to a standstill, a predetermined number of symbols (e.g., three symbols) are displayed on the display windows 2 for respective spinning reels. Further, the sub display section 330 is embodied by the liquid-crystal display device 3 shown in FIG. 1, a CRT monitor, or the like. In accordance with a signal output from the control section 320, the sub display section 330 displays on the main display section 310 display areas corresponding to respective symbol display positions. The operation section 350 is embodied by the three stop buttons 5, the start lever 6, and the bet button 7 and receives an operation instruction entered by the player.

The control section 320 is embodied as a CPU or the like and performs computing operations, such as a spinning reel drive control, various display control operations, and a game progress control operation. The first current displayed symbol determination section 321 determines that symbol “RED7” corresponding to a “first predetermined symbol” described in claims is currently displayed in an arbitrary symbol display position on the main display section 310. The second current displayed symbol determination section 323 determines that symbol “BLUE7” corresponding to a “second predetermined symbol” described in claims is currently displayed in an arbitrary symbol, display position on the main display section 310. When the first current displayed symbol determination section 321 has determined that the symbol “RED7” is currently displayed, the status change section 322 changes, from an initial state corresponding to “invalid state” described in claims to a “7” displayed state corresponding to a “valid state” in claims, the status of a display area on the sub display section 330 corresponding to a symbol display position on the main display section 310 at which the symbol “RED7” is displayed. When the second current displayed symbol determination section 323 has determined that the symbol “BLUE7” is currently displayed, the status change section 322 changes, from the “7” displayed status to the initial state, the status of the display area corresponding to the symbol display position on the main display section 310 at which the symbol “BLUE7” is displayed. (A display area in which “7” is being displayed is hereinafter referred to as a “7” displayed area, and a display area of initial state is hereinafter referred to as an “initial display area.”)

The valid combination determination section 324 determines whether or not there has been formed a state in which all display a reason the sub display section 330 are “7” displayed areas (this state is hereinafter called a “BINGO”). When the valid combination determination section 324 determines that a BINGO, is achieved through “7” displayed areas, the point bringing section 325 gives points to the player. The setting change section 326 changes settings of various gaming statuses in accordance with the points given by the point bringing section 325 and changes settings pertaining to the number of times wins can be achieved in RB games during the course of a BB game. The first current displayed symbol determination section 321, the second current displayed symbol determination section 323, the status change section 322, the valid combination determination section 324, the point bringing section 325, and the status change section 326 are implemented by a program which runs on the control section 320 (e.g., a CPU or the like element).

The storage section 340 is implemented by volatile or non-volatile semiconductor memory (e.g., RAM, ROM, EEPROM, or flash memory). For instance, the storage section 340 stores various types of game programs, a display control program, various types of video data sets, sound data, and setting data pertaining to various games.

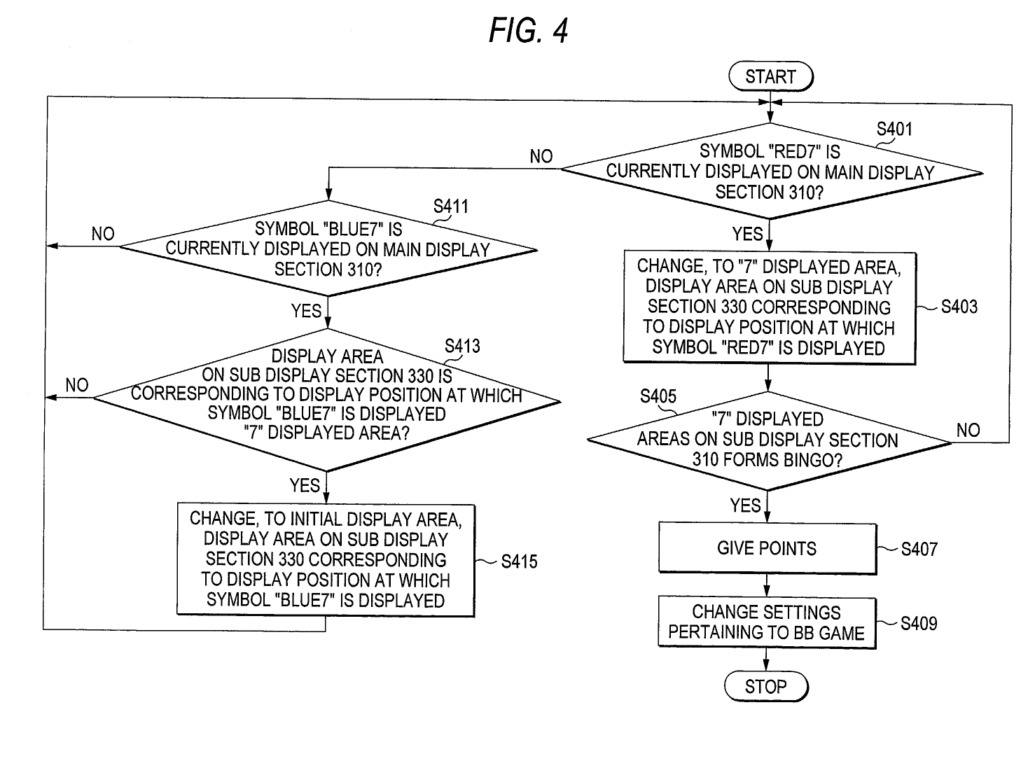

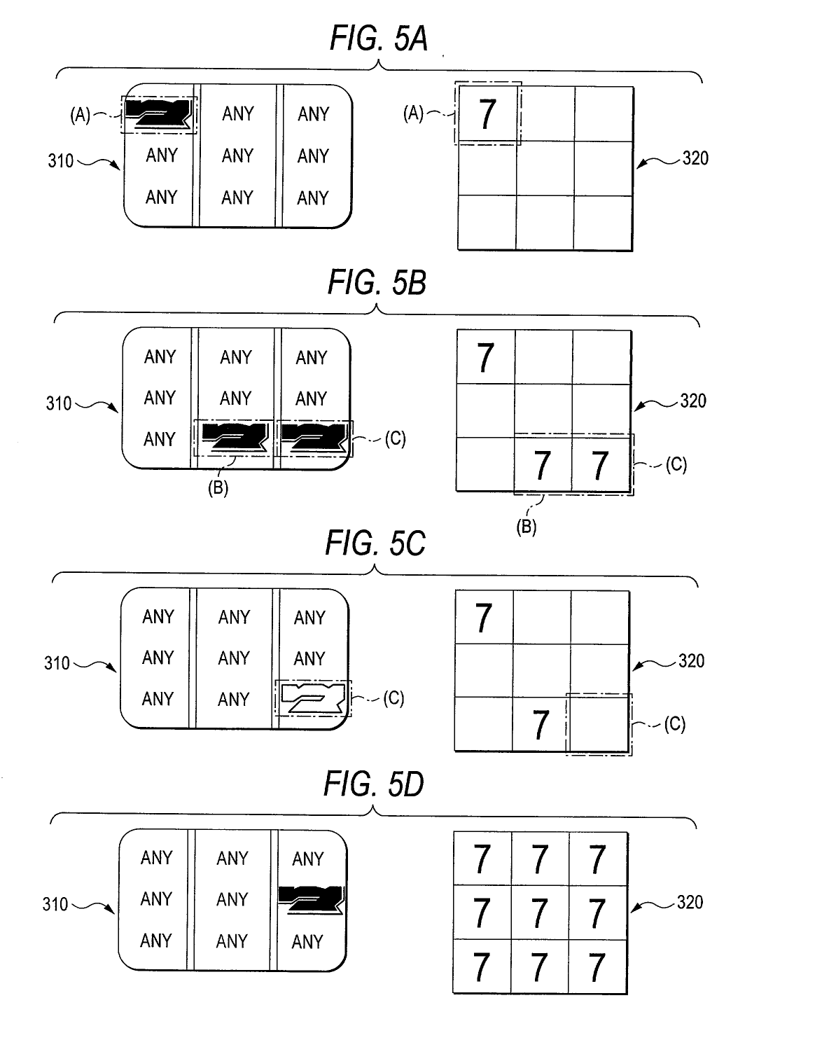

Next, by reference to FIGS. 4 and 5, there will be described processing operation to be performed by a slot machine according to the embodiment having the foregoing constituent elements. FIG. 4 is a flowchart for describing processing to be performed by the slot machine according to the embodiment. FIG. 5 is a descriptive view showing the main display section 310 and the sub display section 330 during the course of processing performed by the slot machine of the embodiment. In step S401, when various symbols are currently displayed on the main display section 310 in a basic game as a result of pressing of the stop button 5, the first current displayed symbol determination section 321 determines whether or not the symbol “RED7” is currently displayed at the symbol display position on the main display section 310. When the first current displayed symbol determination section 321 has determined that the symbol “RED7” is currently displayed at the symbol display position on the main display section 310, processing proceeds to step S403. In step S403, the status change section 322 changes, from the initial state to the “7” displayed state, the state of the display area corresponding to the symbol display position on the main display section 310 at which the symbol “RED7” is displayed. For example, as shown in FIG. 5A, when the first current displayed symbol determination section 321 has determined that the symbol “RED7” is currently displayed in a symbol display position (A) in an upper position on the left row of the main display section 310, the status change section 322 changes, from an initial state to the “7” displayed state, the state of a display area (A) corresponding to the symbol display position (A) on the main display section 310 at which the symbol “RED7” is displayed.

Through determination processing pertaining to step S405, the valid combination determination section 324 determines whether or not the “7” displayed area on the sub display section 330 has formed a BINGO (see FIG. 5D). When, through determination processing pertaining to step S405, the valid combination determination section 324 determines that the “7” displayed area on the sub display section 330 has not formed a BINGO, processing returns to step S401, where the next game is started. For example, as shown in FIG. 5B, when the first current displayed symbol determination section 321 has determined that the symbols “RED7” are currently displayed in a symbol display position (B) in a lower position of the middle row on the main display section 310 and in a symbol display position (C) in a lower position of the right row on the same, the status change section 322 changes, from initial states to “7” displayed states, the states of display areas (B), (C) corresponding to the symbol display positions (B), (C) on the main display section 310 at which the symbols “RED7” are displayed. Since the sub display section 330 shown in FIG. 5B has not achieved a BINGO, the next game is started. The “7” displayed states on the sub display section 330 remain unchanged and intact even when the next game is started.

When the valid combination determination section 324 has determined that the “7” displayed area on the sub display section 330 formed a BINGO (see FIG. 5D) through determination processing pertaining to step S405, processing proceeds to step S407, where the point bringing section 325 gives points to the player. Next, in step S409, the setting change section 326 changes settings pertaining to the number of times wins can be achieved in RB games during the course of a BB game, which are stored in the storage section 340, to normal settings; namely, three to five times.

Here, settings of five RB games are for the purpose of illustration, and the invention is not limited to these settings. The settings are intended for describing that the net number of game medals which can be acquired through a BB game increases. Hence, through preliminary determination based on internal random selection, there may be set a flag for a BB game (e.g., a super BB game) whose settings pertaining to the number of obtainable game medals differ from those for an ordinary BB game. When symbols that would forms a BB game are currently displayed along a valid winning line on the main display section, the game may proceed to the super BB game.

When the first current displayed symbol determination section 321 has determined that the symbol “RED7” is not currently displayed at the symbol display position on the main display section 310, through determination processing pertaining to step S401, processing proceeds to step S411. Through determination processing pertaining to step S411, the first currently-display symbol determination section 321 determines whether or not a symbol “BLUE7” is currently displayed on the main display section 310. When the second current displayed symbol determination section 323 has determined that the “BLUE7” is currently displayed on the main display section 310, processing proceeds to step S413.

Through determination processing pertaining to step S413, a determination is made as to whether or not the state of a display area on a display section corresponding to the symbol display position on the main display section 310 at which the symbol “BLUE7” is currently displayed is already the “7” displayed area. When the state of the display area on the display section corresponding to the symbol display position on the main display section 310 at which the symbol “BLUE7” is currently displayed is already a “7” displayed area, processing proceeds to step S415. In step S415, the status change section 322 changes, from the “7” displayed state to an initial state, the state of the display area corresponding to the symbol display position on the main display section 310 at which the “BLUE7” is displayed. For instance, as shown in FIG. 5B, it is assumed that the state of a display area (C) on the sub display section 330 corresponds to a “7” displayed area as a result of games up to a previous game. In this case, as shown in FIG. 5C, if the “BLUE7” symbol is currently displayed at the symbol display position (C) on the main display section 310 corresponding to the display area (C), the status change section 322 changes, from the “7” displayed state to an initial state, the state of the display area (C) corresponding to the display position (C) on the main display section 310 at which the “BLUE7” is currently displayed.

Even when a symbol other than the symbols “RED7” and “BLUE7” is currently displayed at the symbol display position on the main display section 310 corresponding to the “7” displayed area on the sub display section 330, during the course of games subsequent to the next game, the “7” displayed state on the sub display section 330 is retained intact.

When stationary display of the symbol “BLUE7” on the main display section 310 is not detected through determination processing pertaining to step S411; namely, when a symbol other than the symbols “BLUE7” and “RED7” is currently displayed at the symbol display position on the main display section 310, processing returns to step S401. Through determination processing pertaining to step S413, when the state of the display area on the display section corresponding to the symbol display position on the main display section 310 at which the symbol “BLUE7” is currently displayed does not correspond to the “7” displayed area, processing returns to step S401.

As has been described, according to the slot machine of the embodiment, the first current displayed symbol determination section 321 determines whether or not the symbol “RED7” is currently displayed in an arbitrary symbol display position of the main display section 310. On the basis of the result of determination made by the first current displayed symbol determination section 321, the status change section 322 changes, from an initial state to a valid state, the state of a display area corresponding to the symbol display position at which the symbol “RED7” is currently displayed. The valid combination determination section 324 determines whether or not a valid display area on the sub display section 330 has formed a predetermined valid combination. On the basis of a result of determination made by the valid combination determination section 324, the point bringing section 325 gives points to the player.

A game which has an element of giving points and is to be played on the sub display section 330 is added to the game to be played on the main display section 310 in a basic game. As a result, a feeling of expectation of acquisition of points can be given during a game to be played in a basic game. Hence, the gaming characteristic of a game to be played in a basic game can be enhanced to a much greater extent. Consequently, there can be expected an increase in profits of an arcade or parlor where such a game machine having a higher gaming characteristic is to be installed.

The second current displayed symbol determination section 323 determines whether or not the symbol “BLUE7” is currently displayed at an arbitrary display position on the main display section 310. On the basis of a result of determination made by the second current displayed symbol determination section, the status change section 322 changes, to the initial state, the state of the display area corresponding to the symbol display position at which the symbol “BLUE7” is currently displayed.

When the second current displayed symbol determination section 323 determines that the symbol “BLUE7” is currently displayed at an arbitrary display position on the main display section 310, the status change section 322 changes, to the initial state, the state of the display area corresponding to the symbol display position at which the symbol “BLUE7” is currently displayed. Hence, there is a fear of the valid display area being brought into its initial state when the symbol “BLUE7” is currently displayed on the main display section 310 after the display area on the sub display section 330 has become valid. Thus, a game to be played in a basic gaming status is broadened, and the gaming characteristic of the game can be enhanced to a much greater extent.

When points are given to the player by the point bringing section 325, the setting change section 326 changes settings pertaining to a gaming status advantageous for the player, on the basis of the thus-given points. Particularly, in relation to settings pertaining to a gaming status advantageous to the player, it is preferable to change settings pertaining to the number of times wins can be achieved through RB games during the course of a BB game or to change settings pertaining to a super BB game which differs from an ordinary BB game in terms of settings pertaining to the number of acquirable game medals. As a result, a game to be played in an ordinary game can be changed such that the number of wins attainable through RB games during the course of a BB game is increased from that determined by ordinary settings. Hence, the player is given a feeling of expectation toward a game played in a basic gaming status. Consequently, the gaming characteristic in the basic gaming status can be enhanced to a much greater extent.

In the embodiment, on the basis of the points given by the point bringing section 325, the setting change section 326 changes the number of wins which can be achieved through RB games during the course of a BB game, as a change in settings of a gaming status advantageous to the player. Alternatively, on the basis of given points, there may be changed settings pertaining to the number of times a small winning combination arises during the course of a game remaining in a basic gaming status, settings pertaining to the number of times a small winning combination arises in a small-winning-combination game during a period of assist time (hereinafter abbreviated as “AT”), or settings pertaining to the probability of occurrence of a replay game during a period of replay time (hereinafter abbreviated as “RT”).

Here, the terms “AT” and “RT” correspond to special game. The special game is a kind of promotional game. The “At” and “RT” define special gaming statuses in which the player can play games in a status more advantageous than a basic gaming status and continue playing until predetermined completion requirements are satisfied. The game status proceeds to the special gaming status, for instance when a prize is won through random selection after completion of a BB game, or inevitably proceeds to the same after the end of the BB game. The “AT” is for informing the player of whether small winning combination will be formed or not. When the player forms the small winning combination through pinpoint stopping action, the number of game medals to be paid can be increased. The “RT” is for a game in which symbols that would form a combination for a replay game are aligned with a high probability. During an “RT”, since symbols that would form a combination for a replay game are aligned with a high probability, the player can expect a win in the next BB winning combination without consumption of game medals. The special game may shift from a basic game at a predetermined probability as well as after completion of a BB game.

In the embodiment, the slot machine includes the setting change section 326 which changes the number of times wins can be achieved through RB games during the course of a BB game in accordance with points gotten by the point bringing section 325. The slot machine may include a game status shift section in place of the setting change section 326. When the valid combination determination section 324 has determined that a BINGO is formed, the game status shift section brings a basic game into a BB game in accordance with points given by the point bringing section 325. Alternatively, when the valid combination determination section 324 has determined that a BINGO is formed and the point bringing section 325 has given points to the player, the game status shift section may set a flag for a BB winning combination through preliminary determination stemming from the internal random selection performed in the control section 320. As a result, a game to be played in a basic game can be taken as a game which can be shifted to a BB game in which an increase in the number of acquirable game medals is expected. Hence, the player can have a feeling of expectation in a game to be played in a basic game. Consequently, a gaming characteristic of a game in a basic game can be enhanced to a much greater extent.

In the embodiment, the slot machine includes the setting change section 326 which changes the number of times wins can be achieved through RB games during the course of a BB game in accordance with points given by the point bringing section 325. The slot machine may include a game medal payout section in place of the setting change section 326. When the valid combination determination section 324 has determined that a BINGO is formed, the game medal payout section pays a predetermined number of game medals in accordance with the points given by the point bringing section 325. Hence, a game to be played in a basic game can be taken as a game which can be shifted to a BB game in which a further increase in the number of acquirable game medals is expected. Hence, the player can have a feeling of expectation in a game to be played in a basic game. Consequently, a gaming characteristic of a game in a basic game can be enhanced to a much greater extent.

Second Embodiment

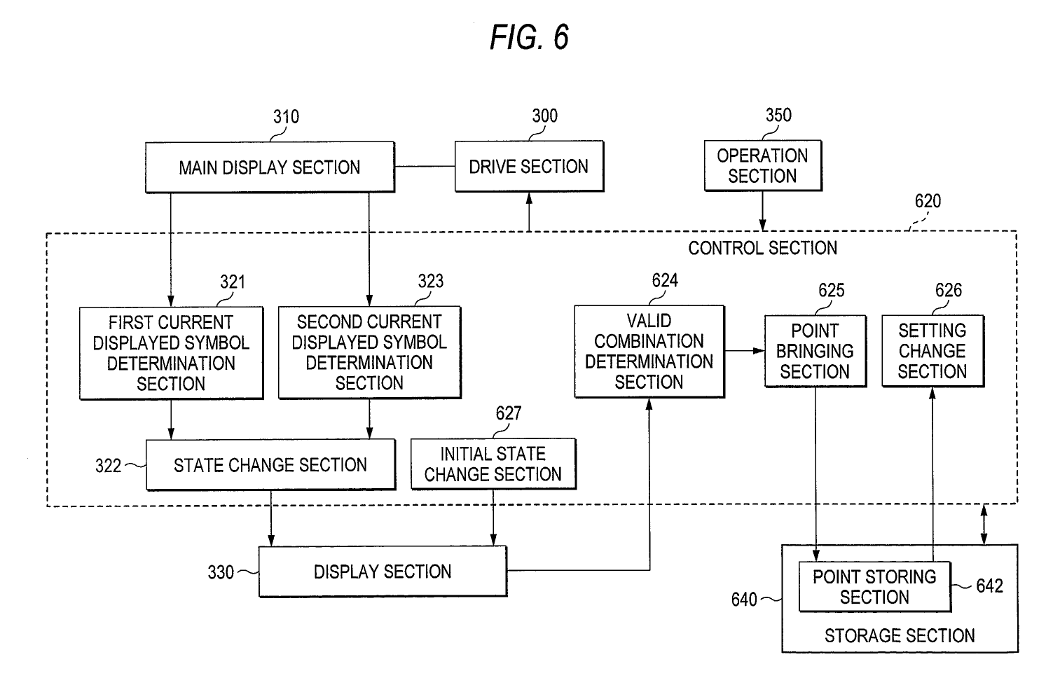

FIG. 6 is a block diagram showing a slot machine according to a second embodiment of the invention. In the drawing, those elements which coincide with those shown in FIG. 3 are assigned the same reference numerals, and their explanations are omitted. As shown in FIG. 6, the slot machine of the embodiment differs from that of the first embodiment shown in FIG. 1 in the following point. Specifically, the control section 320 of the slot machine according to the first embodiment comprising the first current displayed symbol determination section 321, the second current displayed symbol determination section 323, the status change section 322, the valid combination determination section 324, the point bringing section 325, and the setting change section 326 is changed to a control section 620 according to the second embodiment comprising the first current displayed symbol determination section 321, the second current displayed symbol determination section 323, the status change section 322, a valid combination determination section 624, a point bringing section 625, a setting change section 626, and an initial state change section 627. Allocated to a predetermined area in a storage section 640 is a point storing section 642 for temporarily storing points given by the point bringing section 625.

Here, the valid combination determination section 624 determines a plurality of types of “7” displayed combinations on the sub display section 330. The plurality of types of “7” displayed combinations include, for example, a single-line BINGO (i.e., three “7” displayed areas are aligned longitudinally or laterally on the sub display section 330 of 3-by-3 matrix pattern consisting of nine areas); a double-line BINGO (i.e., at least five “7” displayed areas are longitudinally, laterally, or diagonally aligned in two lines on the sub display section 330, including an overlapping “7” displayed area); and a BINGO (all areas on the sub display section 330 are changed into “7” displayed areas). The point storing section 642 is implemented as a predetermined area of the storage section 640. The point storing section 642 retains points based on the type of the valid combination determined by the valid combination determination section 624.

When the valid combination determination section 624 has determined that a predetermined “7” display combination is formed from “7” displayed areas, the point bringing section 625 is gotten points in accordance with the type of the “7” displayed combination determined by the valid combination determination section 624. For instance, when the valid combination determination section 624 determines a formed pattern to be a single-line BINGO, the point bringing section 625 gives 10 points to the player. When the valid combination determination section 624 determines a formed pattern to be a double-line BINGO, the point bringing section 625 gives 30 points to the player. When the valid combination determination section 624 determines a formed pattern to be a BINGO, the point bringing section 625 gives 100 points to the player. In a case where the player issues an instruction by way of the operation section 350 when having determined that the “7” displayed combination determined by the valid combination determination section 624 is formed, the points stored in the point storing section 642 are given. As a result, even when a single-line BINGO has already been formed of the “7” displayed areas on the sub display section 330, the player can temporarily store the points in the point storing section 642 according to his/her own judgment until a double-line BINGO is formed. The point bringing section 625 gives, to the player, the points held in the point storing section 642 at a timing at which the player presses a specific button (e.g., the bet button can be used also as a specific button, or a special button may be provided).

The setting change section 626 changes settings pertaining to respective types of gaming statuses in accordance with the points given by the point bringing section 625 and changes settings pertaining to the number of wins which can be achieved through RB games during a BB game. The initial state change section 627 corresponds to a invalid state change unit described in claims. When the number of times symbols are currently displayed on the main display section 310 has reached a predetermined number; i.e., when a predetermined number of games have been played (e.g., 50 games), the states of all display areas on the sub display section 330 are reset to an initial state. The initial state change section 627, the valid combination determination section 624, the point bringing section 625, and the setting change section 626 are embodied by a program which runs on the control section 620 (e.g., a CPU).

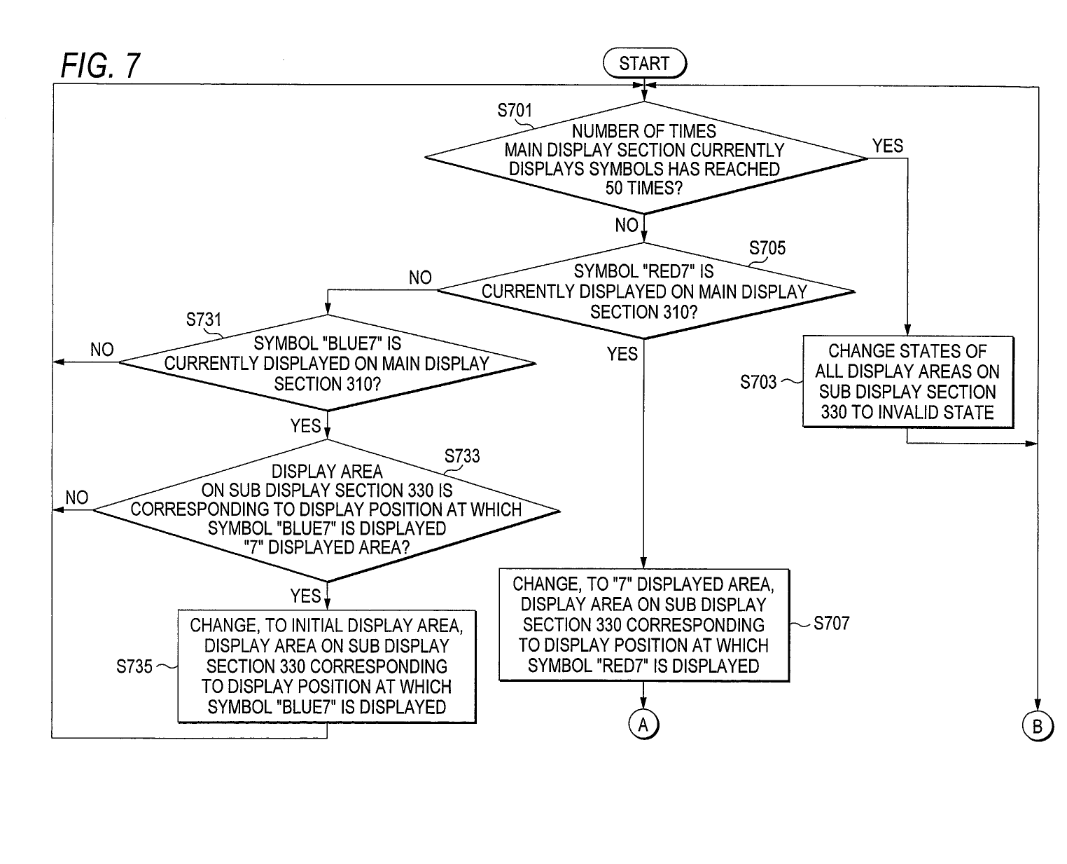

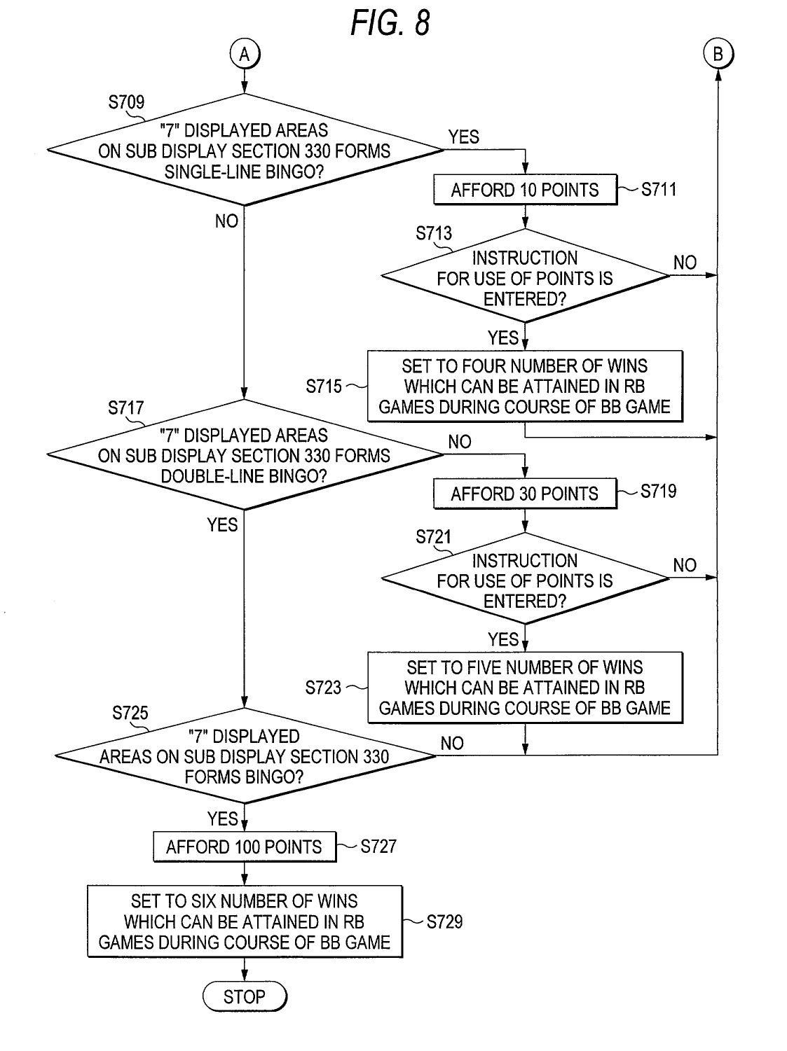

With reference to FIGS. 7 and 8, processing to be performed by a slot machine according to the embodiment having the foregoing constituent elements will now be described. FIGS. 7 and 8 are flowcharts for describing processing to be performed by the slot machine of the embodiment. When various types of symbols are currently displayed on the main display section 310 in a basic game by means of depression of the stop button 5, a determination is made as to whether or not the number of times symbols have been currently displayed on the main display section 310 has reached 50 times through determination processing pertaining to step S701. When the number has reached 50 times, processing proceeds to step S703. In step S703, all the display areas on the sub display section 330 are changed to their initial states by the initial state change section 627. When the number of times symbols have been currently displayed on the main display section 310 is determined not to have reached 50 times through determination processing pertaining to step S701, processing proceeds to step S705.

Processing pertaining to steps S705 and S707 shown in FIG. 7 is identical to that pertaining to steps S401 and S403 shown in FIG. 4, and hence its explanation is omitted. Through determination processing pertaining to step S709, the valid combination determination section 624 determines whether or not the “7” displayed areas on the sub display section 330 form a single BINGO line. When the valid combination determination section 624 determines that the “7” displayed areas on the sub display section 330 form a single-line BINGO, processing proceeds to step S711, wherein the point awarding section gives 10 points to the player. Processing then proceeds to step S713, where a determination is made as to whether or not the player who uses the thus-given points has entered an instruction by way of the operation section 350.

When the player has entered an instruction pertaining to use of the imparted points by way of the operation section 350, processing proceeds to step S715. The setting change section 626 changes, from three times in normal times to four times, settings pertaining to the number of wins which can be achieved through RB games during a BB game. In contrast, if the instruction pertaining to use of the given points is determined not to have been entered by means of determination processing pertaining to step S713, the given points are held in the point storing section 642 within the storage section 640, and processing returns to step S701.

When, through determination processing pertaining to step S709, the valid combination determination section 624 has determined that the “7” displayed areas on the sub display section 330 do not form a single-line BINGO, processing proceeds to step S717. Processing pertaining to steps S717 through S723 is for a case where the valid combination determination section 624 has determined that the “7” displayed areas on the sub display section 330 form a double-line BINGO. Processing pertaining to steps S725 through S729 is for a case where the valid combination determination section 624 has determined that the “7” displayed areas on the sub display section 330 form a BINGO. Since processing is identical with that pertaining to steps S709 through S715, exclusive of the number of lines forming a BINGO and points to be given in accordance with the number of lines (30 points are imparted for a double-line BINGO, and settings pertaining to the number of times a win can be achieved through RB games are changed to five times; and 50 points are imparted for a triple-line BINGO, and settings pertaining to the number of times a win can be achieved through RB games are changed to six times). Processing pertaining to steps S731 through S735 shown in FIG. 7 is identical with that pertaining to step S411 through S415 shown in FIG. 4, and hence its explanations are omitted.

Here, settings of four, five, or six RB games are for the purpose of illustration, and the invention is not limited to these settings. The settings are intended for describing that the net number of game medals which can be acquired through a BB game increases. Therefore, there may be prepared BB games, which differ from an ordinary BB game in terms of settings pertaining to the number of acquirable game medals, equal in number to the types of “7” displayed combinations. When BB symbols are aligned with a valid winning line on the main display section, processing may proceed to the corresponding BB game. Here, the embodiment has described cases where the “7” displayed areas form a single-line BINGO, a double-line BINGO, and a BINGO. The same also applies to a case where a line BINGO is formed of a different number of lines. In the same manner, the embodiment is also applicable to various alternatives of the setting change section 626 described in connection with the first embodiment.

As has been described, according to the slot machine of the embodiment, the first current displayed pattern determination section 321 determines whether or not the symbols “RED7” is currently displayed at an arbitrary symbol display position on the main display section 310. On the basis of a result of determination made by the first current displayed pattern section 321, the state change section 322 changes, from an initial state to a valid state, the state of a display area corresponding to the symbol display position at which the symbol “RED7” is currently displayed. The valid combination determination section 624 determines whether or not the valid display area on the sub display section 330 forms a predetermined valid combination. On the basis of a result of determination made by the valid combination determination section 624, the point bringing section 625 gives points to the player.

A game which has an element of giving points and is to be played on the sub display section 330 is added to the game to be played on the main display section 310 in a basic game.

As a result, a feeling of expectation of acquisition of points can be given during a game to be played in a basic game. Hence, the gaming characteristic of a game to be played in a basic game can be greatly enhanced. Consequently, an arcade or parlor where such a game machine having a higher gaming characteristic is to be installed can expect an increase in profits.

The point bringing section 625 gives points to the player in accordance with the type of predetermined valid combinations. In this way, predetermined valid combinations of a plurality of types are available, and the point bringing section 625 gives points in accordance with the type of predetermined valid combination. Hence, a game to be played in a basic gaming status is broadened, and the gaming characteristic of the game can be greatly enhanced.

The point storing section 642 stores points given on the basis of the result of determination made by the valid combination determination section 624. The point bringing section 625 gives the points stored in the point storing section 642, at a timing instructed by the player. Accordingly, the player can determine, according to his/her judgment, whether the points stored in the point storing section 642 are gotten immediately or only after formation of a valid combination which enables acquisition of a greater number of points. Hence, a game to be played in a basic gaming status is broadened, and the gaming characteristic of the game can be greatly enhanced.

When the number of times the main display section 310 currently displays symbols has reached a predetermined level, the initial state change section 627 changes the states of all display areas on the sub display section 330 to their initial states. In this way, when the number of times the main display section 310 currently displays symbols; that is, when the number of games played in a basic game has reached a predetermined level, the initial state change section 627 has changed the states of all display areas on the sub display section 330 to their initial states. For this reason, the player must form a predetermined valid combination on the sub display section 330 in a basic game within a predetermined number of times. Further, when a certain valid combination is formed, the player determines whether points to be given for the valid combination are given immediately or stored in the point storing section 624. Thus, games are given a level of diversity, thereby broadening games to be played in a general playing state and greatly enhancing a gaming characteristic.

As has been described, the invention provides a game machine which gives a player a feeling of expectation in a game played in a basic game and enables further enhancement of a gaming characteristic of a game in a basic game.

What is claimed is:

1. A game machine comprising:
a main display unit for displaying a plurality of spinning reels having a plurality of symbols;
a sub display unit including display areas corresponding to respective symbol display positions of the main display unit;
a controller for spinning and stopping the reels such that at least one symbol on each reel is displayed to a player of the game machine;
a first current displayed symbol determination section for determining whether or not a first predetermined symbol is currently displayed at an arbitrary display position on the main display unit;
a state change unit which changes, from an invalid state to a valid state, the state of the display area corresponding to the symbol display position at which the first predetermined symbol is currently displayed, on the basis of a result of determination made by the first current displayed symbol determination section;
a valid combination determination unit for determining whether or not the valid display area on the sub display unit forms a predetermined combination; and
a point bringing unit for getting points in accordance with a result of determination made by the valid combination determination unit.

2. The game machine according to claim 1, wherein the point bringing unit gets points in accordance with the type of the predetermined valid combination.

3. The game machine according to claim 1, further comprising a point storing unit for storing points in accordance with a determination result made by the valid combination determination unit, wherein the point bringing unit is gotten points stored in the point storing unit at a timing instructed by a player.

4. The game machine according to claim 1, further comprising a second current displayed symbol determination unit for determining whether or not a second predetermined symbol is currently displayed at an arbitrary symbol display position on the main display unit,
wherein the state change unit changes, to the invalid state, the state of the display area corresponding to the symbol display position at which the second predetermined symbol is currently displayed, in accordance with a result of determination made by the second current displayed symbol determination unit.

5. The game machine according to claim 1, further comprising a invalid state change unit for changing the states of all display areas on the sub display unit to the invalid state when the number of times the main display unit displays currently display symbols has reached a predetermined level.

6. The game machine according to claim 1, further comprising a game shift unit for shifting a game to a promotional game when value of the points given by the point bringing unit reaches a predetermined value.

7. The game machine according to claim 1, wherein the game advantageous to the player is a future game.

8. The game machine according to claim 1, further comprising a game medal payout controller for paying game medals in accordance with points gotten by the point bringing unit.

9. A method of controlling a game machine including a main display unit for displaying a plurality of spinning reels having a plurality of symbols, a sub display unit including display areas corresponding to respective symbol display positions of the main display unit, and a controller for spinning and stopping the reels such that at least one symbol on each reel is displayed to a player of the game machine, the method comprising the steps of:
first determining whether or not a first predetermined symbol is currently displayed at an arbitrary display position on the main display unit;
changing, from an invalid state to a valid state, the state of the display area corresponding symbol is currently displayed, on the bases of a result of the first determining step;
second determining whether or not the valid display area on the sub display unit forms a predetermined combination; and
getting points in accordance with a result of the second determining step.
